(19) United States
(12) Patent Application Publication
(10) Pub. No.: US 2009/0106682 A1
(43) Pub. Date: Apr. 23, 2009

(54) METHOD AND APPARATUS FOR SELECTING HARDWARE COMPONENTS USING A POINTING DEVICE

(76) Inventors: Sanaa Fahkeri Abdelhadi, Richardson, TX (US); Jennifer Lee Carlucci, Mission Viejo, CA (US); Danling Shi, Austin, TX (US); Christopher J. Tan, Austin, TX (US)

Correspondence Address: IBM CORP (YA);C/O YEE & ASSOCIATES PC, P.O. BOX 802333, DALLAS, TX, 75380, US

(21) Appl. No.: 11/875,051

(22) Filed: Oct. 19, 2007

(51) Int. Cl. G06F 3/048

(52) U.S. Cl. 715/771

(57) ABSTRACT

The illustrative embodiments described herein provide an apparatus and method for selecting hardware components of a computing device. In response to detecting a position of a pointing device, the process identifies a hardware component in a plurality of hardware components associated with the position. The process outputs a signal identifying the hardware component in response to identifying the hardware component. The signal distinguishes the hardware component from other hardware components in the plurality of hardware components. The process executes a function associated with the hardware component in response to receiving a selection of the hardware component from the pointing device.

### BACKGROUND OF THE INVENTION

1. Field of the Invention

The present invention relates generally to a data processing system and in particular to a method and apparatus for selecting hardware components. More particularly, the present invention is directed to a computer-implemented method, apparatus, and computer-usable program code for selecting hardware components using a pointing device.

2. Description of the Related Art

Computing devices typically include user interfaces that allow a user to input data and alert a user about a status of the computing device. For example, most computing devices include a keyboard that allow a user to input characters, such as letters, numbers, punctuation, and symbols, which may be used in applications on the computing system. Many computing device also include system indicators. A system indicator is any set of icons that indicate an attribute of the computing device. The set of icons includes one or more icons. An icon may be any character, symbol, picture, or other viewable design.

Most keyboards require a user to physically touch or depress a desired key in order to input data associated with the key to the computing device. A key is a portion of a keyboard that is associated with a character or function. For example, to type to letter ‘p’, a user would typically have to touch or depress the ‘p’ key on the keyboard. However, disabled users may not be able to physical touch or depress keys, such as users with limited limb mobility or other bodily ailments. Also, due in part to the need for mobile computing devices, some keyboards have become increasingly small in size, thereby increasing the difficulty of depressing one key at a time without depressing surrounding keys. This problem is further compounded if the user that uses the impractically small keyboard is disabled.

One current method that addresses these impracticalities of a typical keyboard presents a virtual keyboard on a graphical user interface. The virtual keyboard is an image on a graphical user interface and does not exist in physical space. Thus, the virtual keyboard is not a hardware component. However, the virtual keyboard used in the current method uses a portion of the graphical user interface that could be used for other applications. Also, the virtual keyboard causes excessive crowding of the graphical user interface.

In addition, the user must maneuver between the virtual keyboard and other applications. For example, the user may have to constantly switch between the virtual keyboard and another application window. In this example, the user may need to repeatedly use “Alt-Tab”, the minimize window function, the maximize window function, and other techniques to switch between the virtual keyboard and another application window. Thus, the user wastes time and effort, resulting in decreased efficiency. In some cases, a disabled user may even be physically unable to perform the maneuvering required by this current method.

Many computing devices, such as laptops, desktop computers, and personal digital assistants, also include system indicators. Usually, these system indicators are physical hardware features that are present on the hardware of the computing device, such as the physical exterior of the computing device or one of the computing device's components.

Currently, system indicators indicate an attribute of the computing device by illuminating or otherwise distinguishing itself to alert the user to the attribute. For example, a hard drive icon, such as a cylinder having a bi-directional line, may be illuminated to alert the user that the hard drive of the computing device is performing an operation. In another example, a network icon, such as “)))”, may, when illuminated, alert a user that the computing device is currently connected or logged into a network. However, despite being visible on the exterior of the computer, these system indicators are not currently selectable by a user, and cannot be used to execute any functions.

Thus, a user may spend an excessive amount of time searching on the graphical user interface for functions that relate to the system indicator. Furthermore, users that do not know the meaning of a particular system indicator have no way of easily obtaining information describing the system indicator.

### SUMMARY OF THE INVENTION

The illustrative embodiments described herein provide an apparatus and method for selecting hardware components of a computing device. In response to detecting a position of a pointing device, the process identifies a hardware component in a plurality of hardware components associated with the position. The process outputs a signal identifying the hardware component in response to identifying the hardware component. The signal distinguishes the hardware component from other hardware components in the plurality of hardware components. The process executes a function associated with the hardware component in response to receiving a selection of the hardware component from the pointing device.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a block diagram of a data processing system is depicted in accordance with an illustrative embodiment of the present invention;

FIG. 2 is an illustration of a computing device in accordance with an illustrative embodiment;

FIG. 3 is an illustration of system indicators for a computing device in accordance with an illustrative embodiment;

FIG. 4 is a block diagram of a system for selecting hardware components using a pointing device in accordance with an illustrative embodiment;

FIG. 5 is a flowchart illustrating a process for selecting hardware components using a pointing device in accordance with an illustrative embodiment; and

FIG. 6 is another flowchart illustrating a portion of a process for selecting hardware components using a pointing device in accordance with an illustrative embodiment.

### DETAILED DESCRIPTION OF THE PREFERRED EMBODIMENT

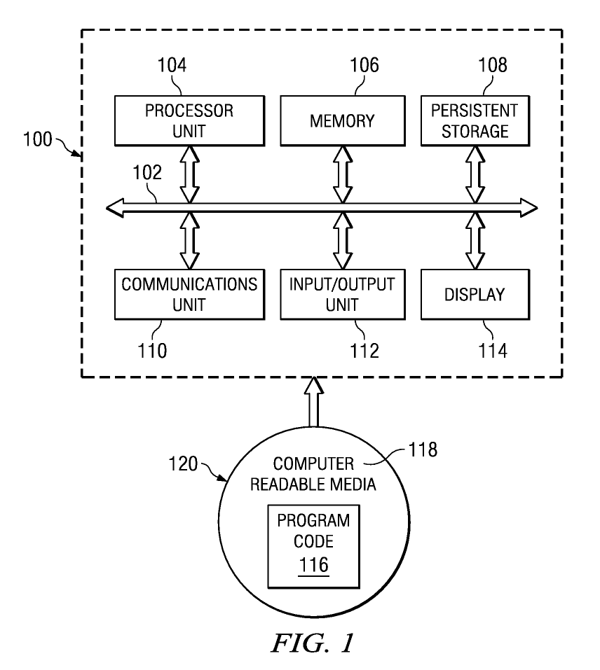

Turning now to FIG. 1, a block diagram of a data processing system is depicted in accordance with an illustrative embodiment of the present invention. In this illustrative example, data processing system 100 includes communications fabric 102, which provides communications between processor unit 104, memory 106, persistent storage 108, communications unit 110, input/output (I/O) unit 112, and display 114.

Processor unit 104 serves to execute instructions for software that may be loaded into memory 106. Processor unit 104 may be a set of one or more processors or may be a multi-processor core, depending on the particular implementation. Further, processor unit 104 may be implemented using one or more heterogeneous processor systems in which a main processor is present with secondary processors on a single chip. As another illustrative example, processor unit 104 may be a symmetric multi-processor system containing multiple processors of the same type.

Memory 106, in these examples, may be, for example, a random access memory or any other suitable volatile or non-volatile storage device. Persistent storage 108 may take various forms depending on the particular implementation. For example, persistent storage 108 may contain one or more components or devices. For example, persistent storage 108 may be a hard drive, a flash memory, a rewritable optical disk, a rewritable magnetic tape, or some combination of the above. The media used by persistent storage 108 also may be removable. For example, a removable hard drive may be used for persistent storage 108.

Communications unit 110, in these examples, provides for communications with other data processing systems or devices. In these examples, communications unit 110 is a network interface card. Communications unit 110 may provide communications through the use of either or both physical and wireless communications links.

Input/output unit 112 allows for input and output of data with other devices that may be connected to data processing system 100. For example, input/output unit 112 may provide a connection for user input through a keyboard and pointing device. A pointing device is any device that a user can move or touch to point to a particular location of a computing device. For example, the pointing device may be a mouse, joystick, laser pointer, stylus, trackball, touchpad mouse. Further, input/output unit 112 may send output to a printer.

Display 114 provides a mechanism to display information to a user. For example, display 114 may be a graphical user interface. In particular, display 114 may display data associated with keys of a keyboard, or a system indicator on data processing system 100.

The hardware of data processing system 100 may also include one or more system indicators. For example, system indicators may indicate an attribute of processor unit 104, memory 106, persistent storage 108, communications unit 110, input/output (I/O) unit 112, display 114, or any other component of data processing system 100.

Instructions for the operating system and applications or programs are located on persistent storage 108. These instructions may be loaded into memory 106 for execution by processor unit 104. The processes of the different embodiments may be performed by processor unit 104 using computer-implemented instructions, which may be located in a memory, such as memory 106. These instructions are referred to as, program code, computer-usable program code, or computer-readable program code that may be read and executed by a processor in processor unit 104. The program code in the different embodiments may be embodied on different physical or tangible computer-readable media, such as memory 106 or persistent storage 108.

Program code 116 is located in a functional form on computer-readable media 118 and may be loaded onto or transferred to data processing system 100 for execution by processor unit 104. Program code 116 and computer-readable media 118 form computer program product 120 in these examples. In one example, computer-readable media 118 may be in a tangible form, such as, for example, an optical or magnetic disc that is inserted or placed into a drive or other device that is part of persistent storage 108 for transfer onto a storage device, such as a hard drive that is part of persistent storage 108. In a tangible form, computer-readable media 118 also may take the form of a persistent storage, such as a hard drive or a flash memory that is connected to data processing system 100. The tangible form of computer-readable media 118 is also referred to as computer recordable storage media.

Alternatively, program code 116 may be transferred to data processing system 100 from computer-readable media 118 through a communications link to communications unit 110 and/or through a connection to input/output unit 112. The communications link and/or the connection may be physical or wireless in the illustrative examples. The computer-readable media also may take the form of non-tangible media, such as communications links or wireless transmissions containing the program code.

The different components illustrated for data processing system 100 are not meant to provide architectural limitations to the manner in which different embodiments may be implemented. The different illustrative embodiments may be implemented in a data processing system including components in addition to or in place of those illustrated for data processing system 100. Other components shown in FIG. 1 can be varied from the illustrative examples shown. Non-limiting examples of data processing system 101 include a desktop computer, a laptop computer, a personal digital assistant, a cellular phone, or any other device that uses the components similar to those in FIG. 1.

For example, a bus system may be used to implement communications fabric 102 and may be comprised of one or more buses, such as a system bus or an input/output bus. Of course, the bus system may be implemented using any suitable type of architecture that provides for a transfer of data between different components or devices attached to the bus system. Additionally, a communications unit may include one or more devices used to transmit and receive data, such as a modem or a network adapter. Further, a memory may be, for example, memory 106 or a cache such as found in an interface and memory controller hub that may be present in communications fabric 102.

The illustrative embodiments described herein provide an apparatus and method for selecting hardware components of a computing device. In response to detecting a position of a pointing device, the process identifies a hardware component in a plurality of hardware components associated with the position. A position is any physical orientation of the pointing device or a user's position relative to the pointing device. In one embodiment, the pointing device is a mouse.

A hardware component is any physical structure or portion thereof included in the computing device. In one embodiment, a hardware component is an input key, a system indicator, or a combination thereof. An input key is any key that responds, in some way, to tactile stimulation. For example, an input key may be a key on a keyboard, a power button, or a brightness button on a graphical user interface.

The process outputs a signal identifying the hardware component in response to identifying the hardware component. A signal may be any communication that is detectable by a user. The signal distinguishes the hardware component from other hardware components in the plurality of hardware components. In one example, the signal is the emission of light from the hardware component. In another example, the signal is the emission of a color of light that is different from the color that was emitted before the hardware component was identified.

The process executes a function associated with the hardware component in response to receiving a selection of the hardware component from the pointing device. As used here, a selection is any indication from the pointing device identifying a particular hardware component, such as a mouse click.

A function is any computer-implemented operation or process. In one example, if selected hardware component is a key of the keyboard, the function may be the input of data associated with the key. For example, if the ‘r’ key of a keyboard is selected, the associated function may be inputting data representing the letter ‘r’.

In one embodiment, the selected hardware component is a particular key of the keyboard. In addition, the process may also receive a second selection of at least one other key of the keyboard from the pointing device. In this embodiment, the executed function is associated with the combination of the both the particular key and other selected key or keys. For example, in the situation in which the combination of keys is “Ctrl-Alt-Delete”, the executed function may be to reset the computer.

In another embodiment, the selected hardware component is a system indicator. In this embodiment, the executed function may be the display of data associated with the particular system indicator on a graphical user interface. For example, in the situation in which the selected system indicator is the hard drive icon, the executed function may be to display the hard drive properties dialog box on the graphical user interface.

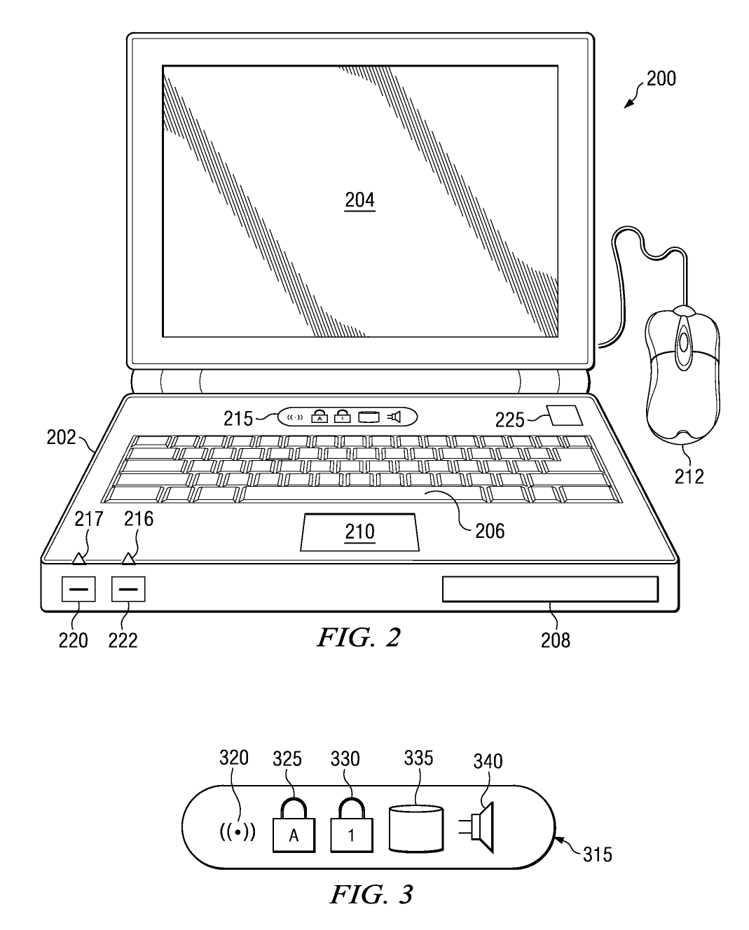

Turning now to FIG. 2, an illustration of a computing device is depicted in accordance with an illustrative embodiment. Specifically, FIG. 2 shows computing device 200, which is a non-limiting example of data processing system 100 in FIG. 1. Computing device 200 includes system unit 202, video display terminal 204, keyboard 206, and storage devices 208, which may include floppy drives and other types of permanent and removable storage media. Computing device 200 may be implemented using any suitable computer, such as an IBM Thinkpad computer, which is a product of International Business Machines Corporation, located in Armonk, N.Y. Also, although computing device 200 is shown as a laptop computer, computing device 200 may also be a desktop computer, a personal digital assistant, a cellular phone, a kiosk, or any other computing device that has input keys or system indicators.

Computing device includes pointing devices 210 and 212. Pointing device 210 is a touchpad mouse that a user may touch to point to a hardware component of computing device 200, such as an input key or system indicator. Pointing device 212 is a mouse. A user may move the mouse to point to a hardware component of computing device 200. Although FIG. 2 depicts pointing device 212 as a mouse, pointing device 212 may also be a joystick, laser pointer, stylus, trackball, or any other device capable of pointing to a location on computing device 200.

Computing device 200 also includes system indicator set 215 and system indicators 216 and 217. In the example shown in FIG. 2, system indicator set 215 includes five icons that each indicates an attribute of computing device 200. System indicators 216 and 217 are each located above USB ports 220 and 222. System indicators 216 and 217 and the icons in system indicator set 215 are capable of being illuminated. Specifically, each of system indicators 216 and 217 and the icons in system indicator set 215 emit light to indicate an attribute of computing device 200. For example, system indicators 216 and 217 may be illuminated when a USB device is plugged into USB ports 220 and 222, respectively.

Although system indicator set 215 is shown just above keyboard 206 in FIG. 2, system indicator set 215 may be located anywhere on the exterior of computing device 200. Also, although the icons in system indicator set 215 are shown adjacent to one another, the icons in system indicator set 215 may also be located anywhere on the exterior of computing device 200. For example, the icons in system indicator set 215 may be dispersed at various locations on the exterior of computing device 200. Additional details regarding the icons in system indicator set 215 will be described below with respect to FIG. 3.

Computing device 200 also includes input keys. For example, computing device includes the keys on keyboard 206. The keys on keyboard 206 include characters, such as letters, numbers, punctuation, symbols, and combinations thereof. Each of the input keys on computing device 200, including the keys on keyboard 206 and power button 225, are capable of being illuminated. For example, power button 225 and each key on keyboard 206 may each individually emit light. In another example, one or more characters on each of the keys on keyboard 206 may illuminate. In this example, the actual character on the key, as opposed to the entire key, emits light. In another example, each input key is capable of illuminating an indicator shape, such as a dot or an arrow, which signals to a user that the input key is currently identified.

In one embodiment, as pointing device 212 is moved by a user, a different one of system indicators 216 and 217, the icons in system indicator set 215, power button 225, or a key on keyboard 206 is identified by being illuminated. Thus, a user may illuminate one of system indicators 216 and 217, the icons in system indicator set 215, power button 225, or a key on keyboard 206 by moving pointing device 212. For example, if the currently illuminated key is the ‘a’ key on keyboard 206, a user may illuminate the ‘s’ key on keyboard 206 by moving pointing device 212 slightly to the right. In another example, if the currently illuminated key is one of the icons in system indicator set 215, the user may illuminate the ‘y’ key on keyboard 206 by moving pointing device 212 down. In this manner, each of system indicators 216 and 217, the icons in system indicator set 215, power button 225, and the keys on keyboard 206 may be illuminated using the movement of pointing device 212. Hence, the currently identified hardware component corresponds to the location of pointing device 212.

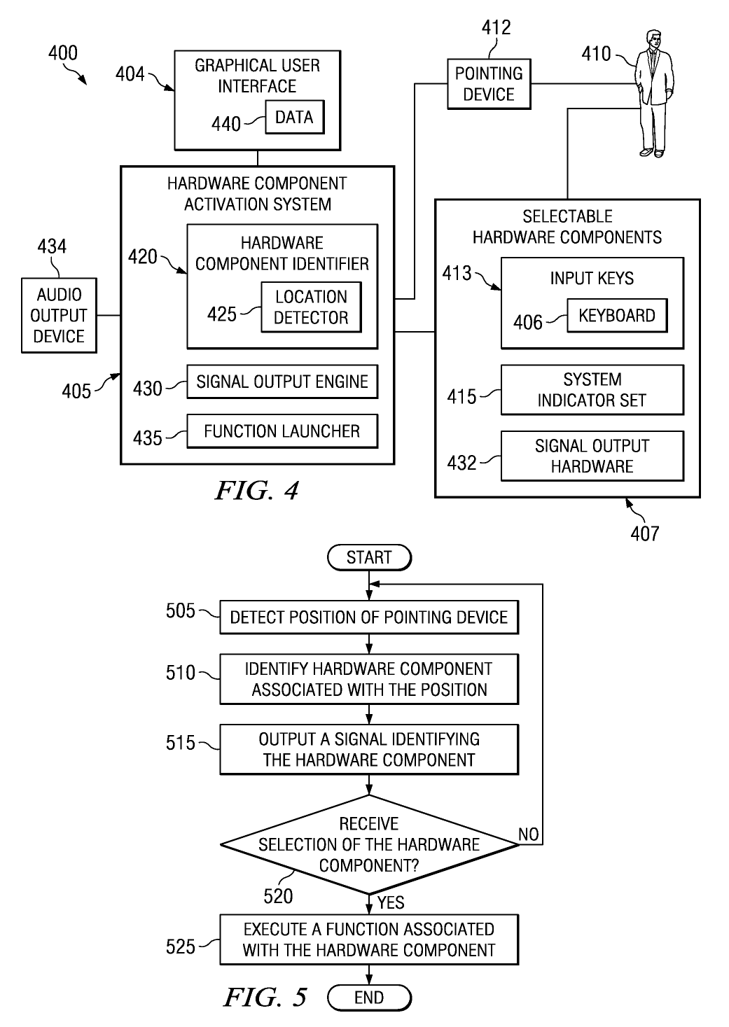

The identification of the hardware component, which occurs in response to the position of pointing devices 210 or 212, distinguishes the hardware component from other hardware components on computing device 200 that are not selected. For example, if the ‘a’ key is the only key on keyboard 206 that is illuminated, then the illumination of the ‘a’ key distinguishes the ‘a’ key from the other keys on keyboard 206. Illumination is only one of a variety of ways that system indicators 216 and 217, the icons in system indicator set 215, power button 225, or a key on keyboard 206 may be identified. Other ways of distinguishing these hardware components from one another using signals will be discussed below with respect to FIGS. 3 and 4.

In another embodiment, a user may identify individual characters on the keys on keyboard 206 by moving pointing device 212. For example, if the ‘&’ symbol is currently illuminated on a key that includes both the ‘&’ symbol and number ‘7’, the user may illuminate the number ‘7’ by moving pointing device 212 slightly down. In this embodiment, each character on the keys that include two or more characters may be capable of illuminating independently of one another. In another embodiment, individual characters are identified by displaying an indicator shape, such as an arrow or dot, next to the identified character.

Illumination for each of system indicators 216 and 217, the icons in system indicator set 215, power button 225, and the keys on keyboard 206 may be provided by any source. For example, a light may be shone from under each of system indicators 216 and 217, the icons in system indicator set 215, power button 225, and the keys on keyboard 206 as each of these hardware components are illuminated. In another example, the hardware components themselves emit light. Any lighting technology may be used to illuminate the hardware components of computing device 200, such as florescence and light emitting diode (LED) technology.

Pointing device 210, which is a touchpad mouse, may be used in the same way as all of the examples given above using pointing device 212, except that pointing device 210 uses a contact point between the touchpad and the user to determine which of system indicators 216 and 217, the icons in system indicator set 215, power button 225, and the keys on keyboard 206 should be illuminated. By changing the location of the point of contact between pointing device 210 and another object, such as the user's finger, the user may change the currently identified hardware component.

Upon identification of a particular hardware component using pointing devices 210 and 212, a user may then select one of system indicators 216 and 217, the icons in system indicator set 215, power button 225, or key on keyboard 206. For example, if the ‘a’ key on keyboard 206 is currently identified, the user may press a button on pointing device 212 to select the ‘a’ key. Similarly, if an icon in system indicator set 215 is currently identified, the user may press a button on pointing device 212 to select the identified icon.

Pressing a button on pointing devices 210 and 212 is only one non-limiting example of how a user may select an identified hardware component. The identified hardware component may be selected using any data transmission method capable of sending data within computing device 200. For example, an identified hardware component may be selected by tapping the touchpad of pointing device 210. In another example, an identified hardware component may be selected by moving a scroll wheel on pointing device 212. In another example, an identified hardware component may be selected by single or double clicking one of pointing devices 210 and 212.

Regardless of the selection method used, a function may then be executed by computing device 200 in response to a selection of a hardware component. Additional details regarding the types of functions executed in response to the selection of a hardware component are given below with respect to FIG. 4.

Although, in these examples, a single key is selected by a user using pointing devices 210 and 212, any number of keys may be selected concurrently by a user. For example, after selecting an input key, such as ‘a’, by clicking pointing device 212, a user may then select an identified input key other than ‘a’, such as “shift”. In this example, the user may afterwards double click pointing device 212 to indicate that the user is finished selecting a combination of keys. In this example, the combination of keys is “Shift” and “a”. The resulting function is that a capital “A” is input to computing device 200.

In another example, a user may select the “Ctrl” button using pointing device 212. Thereafter, the user may select the “Alt” and “Delete” input keys. In this example, the user may indicate the finality of the input key selection by clicking a specialized button on pointing device 212. Upon clicking the specialized button, the resulting function may be that computing device 200 is rebooted or a special dialog box appears on video display terminal 204. In addition to double clicking and clicking a specialized button, any input from the user may be used to indicate the finality of an input key combination selection, such as a triple click, the turn of a scroll wheel, or any other combination of clicks of the buttons on pointing devices 210 and 212.

Turning now to FIG. 3, an illustration of system indicators for a computing device is depicted in accordance with an illustrative embodiment. Specifically, system indicator set 315 is a non-limiting example of system indicator set 215 in FIG. 2.

System indicator set 315 includes five system indicators, each of which indicate an attribute of a computing device, such as data processing system 100 in FIG. 1 and computing device 200 in FIG. 2. Although system indicator set 315 contains five icons, any number of icons may be present in system indicator set 315. Also, although the system indicators in system indicator set 315 are shown as icons in FIG. 3, the system indicators in system indicator set 315 may be represented in any form, such as one or more characters, shapes, or designs.

System indicator set 315 includes wireless indicator 320, capitals lock indicator 325, number lock indicator 330, hard drive indicator 335, and sound indicator 340. Wireless indicator 320 may illuminate when computing device 200 in FIG. 2 is connected to a wireless network. Capitals lock indicator 325 may illuminate when the letter input keys on a keyboard, such as keyboard 206 in FIG. 2, may be used to indicate capital letters instead of lowercase letters. Number lock indicator 330 may illuminate when the number input keys may be used to input numbers. Hard drive indicator 335 may illuminate when the hard drive in computing device 200 in FIG. 2 is performing an operation, such as a read or write operation. Sound indicator 340 may illuminate when computing device 200 in FIG. 2 is set to emit sound, such as when computing device 200 in FIG. 2 is not set to mute. The system indicators that may be included in system indicator set 315 are not limited to those just listed. Instead, system indicators in system indicator set 315 may indicate any attribute of computing device 200 in FIG. 2 or a component thereof.

As shown in the discussion of FIG. 2, a pointing device, such as pointing devices 210 and 212, may be used to identify system indicators, such as wireless indicator 320, capitals lock indicator 325, number lock indicator 330, hard drive indicator 335, and sound indicator 340. In response to identifying one of the icons of system indicator set 315, a signal is outputted by computing device 200 in FIG. 2 that distinguishes the identified icons from other hardware components in computing device 200 in FIG. 2. For example, the identified system indicator in system indicator set 315 may be illuminated. In another example, the color of the identified system indicator in system indicator set 315 may be changed to distinguish the identified system indicator from other system indicators or input keys. In another example, a shape indicator, such as a pointer or an arrow, may appear adjacent to the identified system indicator. In another example, a sound may be emitted from computing device 200 in FIG. 2 that identifies the identified system indicator.

Upon the identification of a system indicator in system indicator set 315, a user may select the system indicator using a pointing device. A function associated with the selected system indicator is then executed. The function may be any computer-implemented operation or process. In one embodiment, the function is the display of data associated with the selected system indicator on a graphical user interface, such as video display terminal 204 in FIG. 2. The data may be presented as a window, dialog box, text, picture, chart, graph, or any other representation of data.

The following non-limiting examples show some of the types of functions that may be executed in response to a user selection. In one example, in response to a user selecting wireless indicator 320, a dialog box that indicates the properties or attributes of the wireless connections of computing device 200 in FIG. 2 may be displayed on video display terminal 204 in FIG. 2. In another example, in response to a user selecting capitals lock indicator 325, a font or text formatting dialog box may be displayed on video display terminal 204 in FIG. 2. In another example, in response to a user selecting number lock indicator 330, a calculator may be displayed on video display terminal 204 in FIG. 2. In another example, in response to a user selecting hard drive indicator 335, a dialog box indicating the properties of the hard drive of computing device 200 in FIG. 2 may be displayed on video display terminal 204 in FIG. 2. In another example, in response to a user selecting sound indicator 340, a dialog box showing the audio settings of computing device 200 in FIG. 2 may be displayed on video display terminal 204 in FIG. 2.

In addition to the non-limiting examples of functions given above, the function that is associated with any of the system indicators in system indicator set 315 may be defined by a user. Thus, a user may choose a function to associate with a particular system indicator, and then be able to easily execute that function by selecting the particular system indicator.

In another embodiment, system indicators in system indicator set 315 may have no function other than being selectable by a user to execute an associated function. Thus, computing device 200 in FIG. 2 may be designed with several icons that allow a user to easily execute pre-defined or user-defined functions.

Turning now to FIG. 4, a block diagram of a system for selecting hardware components using a pointing device is depicted in accordance with an illustrative embodiment. Specifically, FIG. 4 shows hardware component activation system 405 in data processing system 400. Data processing system 400 may be included in another data processing system, such as data processing system 100 in FIG. 1 or computing device 200 in FIG. 2. Hardware component activation system 405 is software, firmware, hardware, or a combination thereof that facilitates selection of a hardware component in a data processing system.

Data processing system 400 includes selectable hardware components 407. Selectable hardware components 407 are any components that may be selected by user 410. Selectable hardware components 407 includes input keys 413. An input key is any key that responds, in some way, to tactile stimulation. For example, an input key in input keys 413 may respond to tactile stimulation from user 410.

Input keys 413 includes keyboard 406. Keyboard 406 is a non-limiting example of keyboard 206 in FIG. 2. Selectable hardware components 407 includes system indicator set 415. System indicator set 415 is a non-limiting example of system indicator set 215 in FIG. 2 and system indicator set 315 in FIG. 3. Non-limiting examples of system indicators that system indicator set 415 may include are wireless indicator 320, capitals lock indicator 325, number lock indicator 330, hard drive indicator 335, and sound indicator 340 in FIG. 3.

Hardware component activation system 405 includes hardware component identifier 420. Location detector 425, which is included in hardware component identifier 420, detects a position of pointing device 412. The detection of a position includes detecting a location or movement of pointing device. Detecting a position may also include detecting a contact point between pointing device 412 and another object, such as user 410. Pointing device 210 in FIG. 2 is one example of a pointing device in which a location detector 425 may detect a contact point.

In response to location detector 425 detecting a position of pointing device 412, hardware component identifier 420 identifies one of selectable hardware components 407. In one embodiment, hardware component identifier 420 identifies one of selectable hardware components 407 using the position of pointing device 412 by referring to a coordinate grid. For example, the position of pointing device 412 may be such that a location on graphical user interface 404 is no longer indicated because location is not on a coordinate grid corresponding to graphical user interface 404. Instead, the location indicated by pointing device 412 may be a location on a coordinate grid that corresponds to selectable hardware components 407.

In one embodiment, in response to hardware component identifier 420 identifying one of selectable hardware components 407, signal output engine 430 outputs a signal identifying the identified hardware component in hardware components 407. The signal distinguishes the identified hardware component from other hardware components in selectable hardware components 407.

In one embodiment, the signal may be outputted using signal output hardware 432. In this embodiment, signal output hardware 432 may output a signal identifying the identified hardware component by illuminating the identified hardware component in selectable hardware components 407. In this embodiment, illuminating the identified hardware component includes changing a color of the identified hardware component in selectable hardware components 407.

In another embodiment, the signal may be outputted using audio output device 434. Audio output device 434 may be any device capable of emitting sound. In this embodiment, audio output device 434 may output a sound identifying the identified hardware component in selectable hardware components 407. For example, audio output device 434 may output the sound for the letter “r” if the “r” key is the identified hardware component in selectable hardware components 407. However, audio output device 434 may output any sound that identifies the identified hardware component in selectable hardware components 407. Other non-limiting examples of signals that may be used to distinguish the identified hardware component from other hardware components in selectable hardware components 407 have been given above with respect to the previous figures.

Hardware component activation system 405 may receive a selection of the identified hardware component from pointing device 412. Non-limiting examples of how the identified hardware component may be selected have been given above with respect to the previous figures.

In response to receiving a selection of the identified hardware component from pointing device 412, function launcher 435 may launch a function associated with the selected hardware component. For example, if the selected hardware component is a key on keyboard 406, function launcher 435 may input data associated with the selected key.

In another example, if the selected hardware component is a system indicator in system indicator set 415, function launcher 435 may display data 440 associated with the selected system indicator on graphical user interface 404. Data 440 may be a graphic, such as a window or a dialog box. For example, data 440 may be a window or other data describing properties of the selected system indicator in system indicator set 415. Additional examples of the types of functions that may be executed by function launcher 435 in response to a selection of a system indicator have been provided with respect to the previous figures. Also, more than one function may be associated with the hardware components in selectable hardware components 407.

In addition, the function executed by function launcher 435 may be defined by user 410. For example, function launcher 435 may provide a user interface on graphical user interface 404 that allows user 410 to associate functions to hardware components in selectable hardware components 407.

In another embodiment, user 410 may select a combination of two or more selectable hardware components 407. For example, after receiving a selection of particular hardware component in selectable hardware components 407, hardware component activation system 405 may receive a second selection of at least one other hardware component in selectable hardware components 407. In this example, the function executed by function launcher 435 may be associated with the combination of hardware components selected by user 410. Non-limiting example of hardware component combinations and their associated function have been provided with respect to the previous figures.

Thus, the illustrative embodiments provide a system that allows a user to select a hardware component of a data processing system, such as an input key or system indicator, and launch a function associated with the selected hardware component. Using this system, a user may easily and conveniently execute a function associated with hardware components using only a single device, such as a pointing device.

Turning now to FIG. 5, a flowchart illustrating a process for selecting hardware components using a pointing device is depicted in accordance with an illustrative embodiment. The process illustrated in FIG. 5 may be performed by a hardware component activation system, such as hardware component activation system 405 in FIG. 4.

The process begins by detecting a position of a pointing device (step 505). The process identifies a hardware component associated with the position (step 510). The process then outputs a signal identifying the hardware component (step 515).

The process determines whether a selection of the identified hardware component is received (step 520). If the process determines that a selection of the identified hardware component is not received, then the process returns to step 505. If the process determines that a selection of the identified hardware component is received, then the process executes a function associated with the selected hardware component (step 525). The process then terminates.

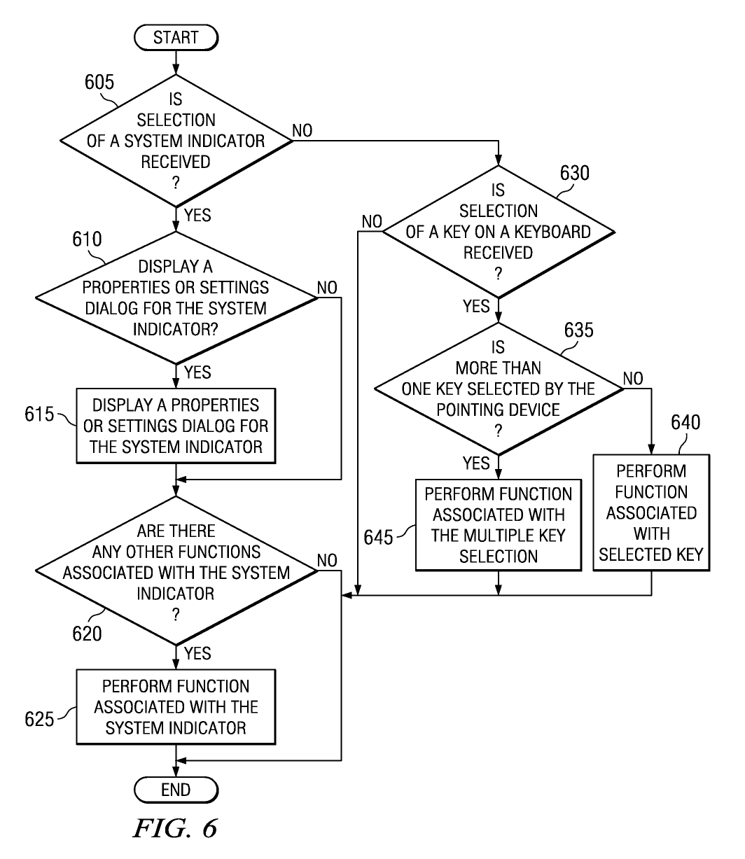

Turning now to FIG. 6, a flowchart illustrating a portion of a process for selecting hardware components using a pointing device is depicted in accordance with an illustrative embodiment. The process illustrated in FIG. 6 may be performed by a function launcher, such as function launcher 435 in FIG. 4. The process illustrated in FIG. 6 is a non-limiting example of steps 520 and 525 in FIG. 5.

The process begins by determining whether a selection of a system indicator is received (step 605). If the process determines that a selection of a system indicator is received, the process determines whether to display a properties or setting dialog for the selected system indicator (step 610). If the process determines not to display a properties or setting dialog for the selected system indicator, the process proceeds to step 620.

Returning to step 610, if the process determines to display a properties or setting dialog for the selected system indicator, the process displays a properties or setting dialog for the selected system indicator (step 615). The process then determines whether there are any other functions, such as user-defined functions, associated with the system indicator (step 620). If the process determines that there are not any other functions associated with the selected system indicator, then the process terminates.

Returning to step 620, if the process determines that there are other functions associated with the selected system indicator, then the process performs the function associated with the selected system indicator (step 625). The process then terminates.

Returning to step 605, if the process determines a selection of a system indicator is not received, the process determines whether a selection of an input key, such as a key on a keyboard, is received (step 630). If the process determines that a selection of an input key is not received, then the process terminates.

Returning to step 630, if the process determines that a selection of an input key is received, the process determines whether more than one input key is selected by the pointing device (step 635). If the process determines that more than one input key is not selected by the pointing device, the process performs a function associated with the associated input key that has been selected (step 640). The process then terminates.

If the process determines that more than one input key is selected by the pointing device, the process performs a function associated with the combination of the selected input keys (step 645). The process then terminates.

The flowcharts and block diagrams in the different depicted embodiments illustrate the architecture, functionality, and operation of some possible implementations of apparatus, methods and computer program products. In this regard, each block in the flowchart or block diagrams may represent a module, segment, or portion of code, which comprises one or more executable instructions for implementing the specified function or functions. In some alternative implementations, the function or functions noted in the block may occur out of the order noted in the figures. For example, in some cases, two blocks shown in succession may be executed substantially concurrently, or the blocks may sometimes be executed in the reverse order, depending upon the functionality involved.

The illustrative embodiments described herein provide an apparatus and method for selecting hardware components of a computing device. In response to detecting a position of pointing device, the process identifies a hardware component in a plurality of hardware components associated with the position. In one embodiment, the pointing device is a mouse.

A hardware component is any physical structure or portion thereof included in the computing device. In one embodiment, a hardware component is an input key, a system indicator, or a combination thereof.

The process outputs a signal identifying the hardware component in response to identifying the hardware component. The signal distinguishes the hardware component from other hardware components in the plurality of hardware components. In one example, the signal is the emission of light from the hardware component. In another example, the signal is the emission of a color of light that is different from the color that was emitted before the hardware component was identified.

The process executes a function associated with the hardware component in response to receiving a selection of the hardware component from the pointing device. In one embodiment, the selected hardware component is a particular key of the keyboard. In addition, the process may also receive a second selection of at least one other key of the keyboard from the pointing device. In this embodiment, the executed function is associated with the combination of both the particular key and other selected key or keys.

In another embodiment, the selected hardware component is a system indicator. In this embodiment, the executed function may be the display of data associated with the particular system indicator on a graphical user interface.

Thus, the illustrative embodiments provide a system that allows a user to select a hardware component of a data processing system, such as an input key or system indicator, and launch a function associated with the selected hardware component. Using this system, a user may easily and conveniently execute a function associated with hardware components using only a single device, such as a pointing device.

For example, keyboard keys that are small in size may be more easily selected, thereby reducing typing errors. The burden on disabled users that have difficulty depressing keys is also alleviated. Additionally, the illustrative embodiments may reduce or eliminate the amount of space used on a graphical user interface because existing hardware components, such as a keyboard, may be used to highlight keys instead of a graphical user interface.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer-readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid-state memory, magnetic tape, a removable computer diskette, a random access memory (RAM), a read-only memory (ROM), a rigid magnetic disk and an optical disk. Current examples of optical disks include compact disk—read only memory (CD-ROM), compact disk—read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories, which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A computer-implemented method for selecting hardware components of a computing device, comprising:
responsive to detecting a position of a pointing device, identifying a hardware component in a plurality of hardware components associated with the position;
responsive to identifying the hardware component, outputting a signal identifying the hardware component, wherein the signal distinguishes the hardware component from other hardware components in the plurality of hardware components; and
responsive to receiving a selection of the hardware component from the pointing device, executing a function associated with the hardware component.

2. The computer-implemented method of claim 1, wherein outputting the signal identifying the hardware component further comprises:
illuminating the hardware component.

3. The computer-implemented method of claim 2, wherein illuminating the hardware component further comprises:
changing a color of the hardware component.

4. The computer-implemented method of claim 2, wherein illuminating the hardware component further comprises:
illuminating an indicator shape on the hardware component.

5. The computer-implemented method of claim 1, wherein the computing device comprises an audio output device, and wherein the signal is a sound identifying the hardware component.

6. The computer-implemented method of claim 1, wherein each of the plurality of hardware components is one of an input key or a system indicator.

7. The computer-implemented method of claim 6, wherein the input key is a particular key of a keyboard, and wherein the function comprises:
inputting data associated with the particular key to the computing device.

8. The computer-implemented method of claim 6, wherein the input key is a particular key of a keyboard, further comprising:
receiving a second selection of at least one other key of the keyboard from the pointing device; and
executing the function, wherein the function is associated with the particular key and the at least one other key.

9. The computer-implemented method of claim 6, wherein the hardware component is a particular system indicator, and wherein the function comprises:
displaying data associated with the particular system indicator on a graphical user interface.

10. The computer-implemented method of claim 1, wherein the function is a user-definable function.

11. The computer-implemented method of claim 1, wherein the pointing device is a mouse.

12. A computer program product comprising:
a computer-usable medium having computer-usable program code for selecting hardware components of a computing device, the computer program product comprising:
computer-usable program code, responsive to detecting a position of a pointing device, for identifying a hardware component in a plurality of hardware components associated with the position;
computer-usable program code, responsive to identifying the hardware component, for outputting a signal identifying the hardware component, wherein the signal distinguishes the hardware component from other hardware components in the plurality of hardware components; and
computer-usable program code, responsive to receiving a selection of the hardware component from the pointing device, for executing a function associated with the hardware component.

13. The computer program product of claim 12, wherein the computer-usable program code for outputting the signal identifying the hardware component further comprises:
computer-usable program code for illuminating the hardware component.

14. The computer program product of claim 12, wherein each of the plurality of hardware components is one of an input key or a system indicator.

15. The computer program product of claim 14, wherein the hardware component is a particular system indicator, and wherein the function comprises:
computer-usable program code for displaying data associated with the particular system indicator on a graphical user interface.

16. The computer program product of claim 12, wherein the pointing device is a mouse.

17. A data processing system comprising:
a bus system;
a memory connected to the bus system, wherein the memory includes a set of instructions; and
a processing unit connected to the bus system, wherein the processing unit executes the set of instructions to identify a hardware component in a plurality of hardware components associated with a position in response to detecting the position of a pointing device; output a signal identifying the hardware component in response to identifying the hardware component, wherein the signal distinguishes the hardware component from other hardware components in the plurality of hardware components; and execute a function associated with the hardware component in response to receiving a selection of the hardware component from the pointing device.

18. The data processing system of claim 17, wherein in outputting the signal identifying the hardware component, the processing unit further executes the set of instructions to illuminate the hardware component.

19. The data processing system of claim 17, wherein each of the plurality of hardware components is one of an input key or a system indicator.

20. The data processing system of claim 17, wherein the pointing device is a mouse.
